(19) United States
(12) Patent Application Publication
(10) Pub. No.: US 2023/0182231 A1
(43) Pub. Date: Jun. 15, 2023

(54) THERMAL RADIATION LIGHT DETECTION DEVICE AND LASER PROCESSING DEVICE

(71) Applicant: HAMAMATSU PHOTONICS K.K., Hamamatsu-shi, Shizuoka (JP)

(72) Inventors: Katsuhisa ITOH, Hamamatsu-shi, Shizuoka (JP); Masaki WATANABE, Hamamatsu-shi, Shizuoka (JP); Satoshi MATSUMOTO, Hamamatsu-shi, Shizuoka (JP); Takenori OHMIYA, Hamamatsu-shi, Shizuoka (JP)

(73) Assignee: HAMAMATSU PHOTONICS K.K., Hamamatsu-shi, Shizuoka (JP)

(21) Appl. No.: 17/923,957

(22) PCT Filed: Apr. 7, 2021
(86) PCT No.: PCT/JP2021/014810

§ 371 Date: Nov. 8, 2022

(30) Foreign Application Priority Data
May 20, 2020 (JP) 2020-087973

(51) Int. Cl. B23K 26/03; G01J 5/60; G01J 5/06

(52) U.S. Cl. CPC B23K 26/034; G01J 5/60; G01J 5/06

(57) ABSTRACT

A thermal radiation light detection device includes: a housing including a plurality of wall portions; a light entrance unit attached to a wall portion and configured to cause thermal radiation light to enter the housing; a light extraction unit disposed inside housing and configured to extract light of a first wavelength and light of a second wavelength from the thermal radiation light, the second wavelength being different from the first wavelength; a first light detection unit attached to a wall portion and configured to detect the light of the first wavelength; a second light detection unit attached to a wall portion and configured to detect the light of the second wavelength; and a first temperature detection unit attached to a wall portion, the wall portion to which the first temperature detection unit is attached being different from the wall portion to which the first light detection unit is attached.

### TECHNICAL FIELD

The present disclosure relates to a thermal radiation light detection device and a laser processing device.

### BACKGROUND ART

A laser processing device has been known that measures a temperature of a region on a workpiece irradiated with laser light by detecting thermal radiation light emitted from the region while processing the workpiece by irradiating the workpiece with the laser light (for example, refer to Patent Literature 1).

### CITATION LIST

### Patent Literature

Patent Literature 1: Japanese Unexamined Patent Publication No. 2006-341563

### SUMMARY OF INVENTION

### Technical Problem

In the above-described laser processing device, the accuracy of measurement of the temperature of the region on the workpiece irradiated with the laser light is reduced by the influence of environmental temperature, which is a concern. Particularly, when the temperature of the region on the workpiece irradiated with the laser light is low (for example, a temperature of 250° C. or less), the influence of the environmental temperature becomes remarkable.

An object of the present disclosure is to provide a thermal radiation light detection device and a laser processing device that enable highly accurate temperature measurement.

### Solution to Problem

A thermal radiation light detection device according to one aspect of the present disclosure includes: a housing including a plurality of wall portions; a light entrance unit attached to a wall portion among the plurality of wall portions and configured to cause thermal radiation light to enter the housing; a light extraction unit disposed inside housing and configured to extract light of a first wavelength and light of a second wavelength from the thermal radiation light, the second wavelength being different from the first wavelength; a first light detection unit attached to a wall portion among the plurality of wall portions and configured to detect the light of the first wavelength; a second light detection unit attached to a wall portion among the plurality of wall portions and configured to detect the light of the second wavelength; and a first temperature detection unit attached to a wall portion among the plurality of wall portions, the wall portion to which the first temperature detection unit is attached being different from the wall portion to which the first light detection unit is attached.

In the thermal radiation light detection device according to one aspect of the present disclosure, the light extraction unit extracts the light of the first wavelength and the light of the second wavelength from the thermal radiation light, the first light detection unit detects the light of the first wavelength, and the second light detection unit detects the light of the second wavelength. Accordingly, a temperature of a region that has emitted the thermal radiation light can be obtained based on a signal output from the first light detection unit and a signal output from the second light detection unit. Here, thermal radiation light emitted from the housing enters at least the first light detection unit, which is a concern. Particularly, thermal radiation light emitted from the wall portions different from the wall portion to which the first light detection unit is attached is likely to enter the first light detection unit. Therefore, in the thermal radiation light detection device according to one aspect of the present disclosure, the first temperature detection unit is attached to the wall portion different from the wall portion to which the first light detection unit is attached. Accordingly, at least the signal output from the first light detection unit can be corrected based on a signal output from the first temperature detection unit. As described above, the thermal radiation light detection device according to one aspect of the present disclosure enables highly accurate temperature measurement.

In the thermal radiation light detection device according to one aspect of the present disclosure, the first temperature detection unit may be attached to a wall portion among the plurality of wall portions, the wall portion to which the first temperature detection unit is attached facing the wall portion to which the first light detection unit is attached. Accordingly, the signal output from the first light detection unit can be corrected with higher accuracy, based on the signal output from the first temperature detection unit. The reason is that thermal radiation light emitted from the wall portion facing the wall portion to which the first light detection unit is attached is more likely to enter the first light detection unit.

In the thermal radiation light detection device according to one aspect of the present disclosure, the first light detection unit may include a first light detection element configured to detect the light of the first wavelength. At least one of the light extraction unit and the first light detection unit may include a first condenser lens configured to condense the light of the first wavelength on the first light detection element. The first temperature detection unit may be located within an FOV of the first condenser lens on the wall portion to which the first temperature detection unit is attached. Accordingly, the signal output from the first light detection unit can be corrected with higher accuracy, based on the signal output from the first temperature detection unit. The reason is that thermal radiation light emitted from a portion of the wall portion to which the first temperature detection unit is attached is more likely to enter the first light detection unit, the portion being within the FOV of the first condenser lens.

The thermal radiation light detection device according to one aspect of the present disclosure may further include a second temperature detection unit attached to a wall portion among the plurality of wall portions, the wall portion to which the second temperature detection unit is attached being different from the wall portion to which the second light detection unit is attached. Accordingly, the signal output from the first light detection unit can be corrected based on the signal output from the first temperature detection unit, and a signal output from the second light detection unit can be corrected based on a signal output from the second temperature detection unit.

In the thermal radiation light detection device according to one aspect of the present disclosure, the second temperature detection unit may be attached to a wall portion among the plurality of wall portions, the wall portion to which the second temperature detection unit is attached facing the wall portion to which the second light detection unit is attached. Accordingly, the signal output from the second light detection unit can be corrected with higher accuracy, based on the signal output from the second temperature detection unit. The reason is that thermal radiation light emitted from the wall portion facing the wall portion to which the second light detection unit is attached is more likely to enter the second light detection unit.

In the thermal radiation light detection device according to one aspect of the present disclosure, the second light detection unit may include a second light detection element configured to detect the light of the second wavelength. At least one of the light extraction unit and the second light detection unit may include a second condenser lens configured to condense the light of the second wavelength on the second light detection element. The second temperature detection unit may be located within an FOV of the second condenser lens on the wall portion to which the second temperature detection unit is attached. Accordingly, the signal output from the second light detection unit can be corrected with higher accuracy, based on the signal output from the second temperature detection unit. The reason is that thermal radiation light emitted from a portion of the wall portion to which the second temperature detection unit is attached is more likely to enter the second light detection unit, the portion being within the FOV of the second condenser lens.

In the thermal radiation light detection device according to one aspect of the present disclosure, the wall portion to which the first light detection unit is attached and the wall portion to which the second light detection unit is attached may be different wall portions, and the wall portion to which the first temperature detection unit is attached and the wall portion to which the second temperature detection unit is attached may be the same wall portion. Accordingly, the disposition of each configuration in the housing can be simplified.

In the thermal radiation light detection device according to one aspect of the present disclosure, the wall portion to which the first light detection unit is attached and the wall portion to which the second light detection unit is attached may be the same wall portion, and the first temperature detection unit may be attached to a wall portion among the plurality of wall portions, the wall portion to which the first temperature detection unit is attached facing the wall portion to which the first light detection unit and the second light detection unit are attached. Accordingly, the signal output from the first light detection unit and the signal output from the second light detection unit can be corrected with higher accuracy, based on the signal output from the first temperature detection unit.

In the thermal radiation light detection device according to one aspect of the present disclosure, the first light detection unit may include a first light detection element configured to detect the light of the first wavelength. The second light detection unit may include a second light detection element configured to detect the light of the second wavelength. At least one of the light extraction unit and the first light detection unit may include a first condenser lens configured to condense the light of the first wavelength on the first light detection element. At least one of the light extraction unit and the second light detection unit may include a second condenser lens configured to condense the light of the second wavelength on the second light detection element. The first temperature detection unit is located in a region where an FOV of the first condenser lens and an FOV of the second condenser lens overlap each other on the wall portion to which the first temperature detection unit is attached. Accordingly, the signal output from the first light detection unit and the signal output from the second light detection unit can be corrected with higher accuracy, based on the signal output from the first temperature detection unit.

The thermal radiation light detection device according to one aspect of the present disclosure may further include a signal processing unit configured to obtain a temperature of a region having emitted the thermal radiation light, based on a signal output from the first light detection unit and a signal output from the second light detection unit. The signal processing unit may correct at least the signal output from the first light detection unit, based on a signal output from the first temperature detection unit. Accordingly, the temperature of the region that has emitted the thermal radiation light can be obtained with high accuracy.

A laser processing device according to one aspect of the present disclosure includes: the thermal radiation light detection device; a laser light source configured to emit laser light; and a light guide unit configured to guide thermal radiation light emitted from a region on a workpiece irradiated with the laser light, to the thermal radiation light detection device.

The laser processing device according to one aspect of the present disclosure enables highly accurate temperature measurement in the region on the workpiece irradiated with the laser light.

### Advantageous Effects of Invention

According to the present disclosure, it is possible to provide the thermal radiation light detection device and the laser processing device that enable highly accurate temperature measurement.

### BRIEF DESCRIPTION OF DRAWINGS

FIG. 1 is a configuration view of a laser processing device according to one embodiment.

FIG. 2 is a cross-sectional view of a thermal radiation light detection device shown in FIG. 1.

FIG. 3 is a cross-sectional view of the thermal radiation light detection device taken along line III-III shown in FIG. 2.

FIG. 4 is a cross-sectional view of a thermal radiation light detection device according to a modification example.

### DESCRIPTION OF EMBODIMENTS

Hereinafter, an embodiment of the present disclosure will be described in detail with reference to the drawings. Incidentally, in the drawings, the same or equivalent portions are denoted by the same reference signs, and a duplicated description will be omitted.

### [Configuration of Laser Processing Device]

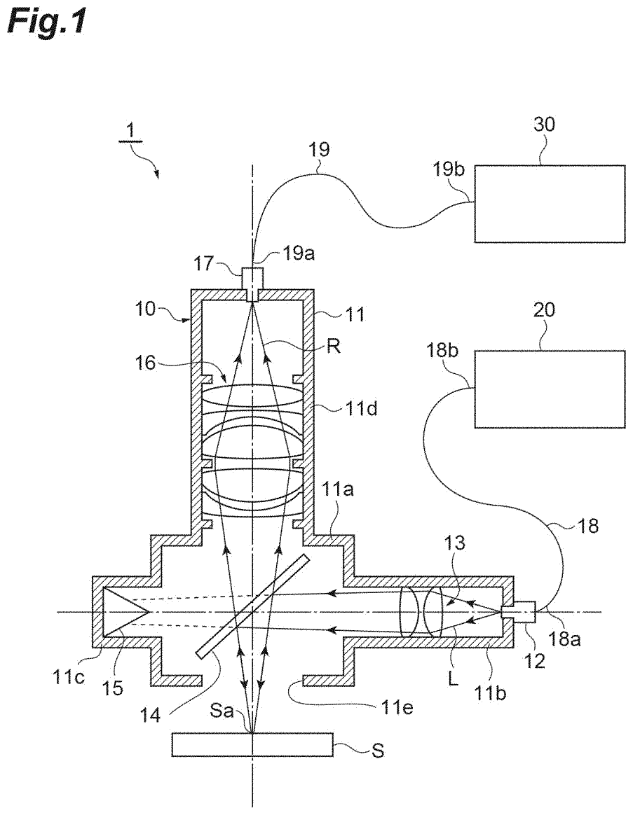

As shown in FIG. 1, a laser processing device 1 includes a laser processing head 10, a laser light source 20, and a thermal radiation light detection device 30. The laser processing device 1 measures a temperature of a region Sa on a workpiece S irradiated with laser light L (hereinafter, referred to as a “laser light irradiation region Sa”) by detecting thermal radiation light R emitted from the laser light irradiation region Sa while processing the workpiece S by irradiating the workpiece S with the laser light L. One example of processing of the workpiece S using irradiation of the laser light L is cutting, welding, surface treatment, or the like. One example of the purpose of measuring the temperature of the laser light irradiation region Sa on the workpiece S is output control of the laser light, a detection of processing defects, or the like.

The laser processing head 10 includes a housing 11, a light entrance unit 12, a first optical system 13, a dichroic mirror 14, a beam trap 15, a second optical system 16, and a light emission unit 17. The laser processing head 10 is configured to be movable with respect to the workpiece S.

The housing 11 is formed of a central portion 11a, a pair of lateral extending portions 11b and 11c, and an upward extending portion 11d. The pair of lateral extending portions 11b and 11c extend opposite to each other from the central portion 11a along a horizontal direction. The upward extending portion extends upward from the central portion 11a along a vertical direction. An opening 11e is formed in a lower wall portion of the central portion 11a.

The light entrance unit 12 is attached to a tip portion of the lateral extending portion 11b. One end portion 18a of an optical fiber 18 is connected to the light entrance unit 12. The other end 18b of the optical fiber 18 is connected to the laser light source 20. The light entrance unit 12 causes the laser light L that is emitted from the laser light source 20 and is guided by the optical fiber 18, to enter the housing 11. As one example, the laser light source 20 is formed of a semiconductor laser and emits the laser light L having a center wavelength of 810 nm.

The first optical system 13 is disposed inside the lateral extending portion 11b. The first optical system 13 condenses the laser light L that has entered from a light entrance unit 12 side, on the workpiece S. As one example, the first optical system 13 is formed of two single lenses, and an anti-reflection film that prevents the reflection of the laser light L is formed on a surface of each of the single lenses.

The dichroic mirror 14 is disposed inside the central portion 11a. The dichroic mirror 14 reflects the laser light L condensed by the first optical system 13, to an opening 11e side. The laser light L reflected by the dichroic mirror 14 passes through the opening 11e, and the workpiece S is irradiated with the laser light L. The thermal radiation light R is emitted from the laser light irradiation region Sa on the workpiece S. The thermal radiation light R emitted from the laser light irradiation region Sa passes through the opening 11e to enter the dichroic mirror 14. The dichroic mirror 14 transmits the thermal radiation light R that has entered from the opening 11e side.

The beam trap 15 is disposed inside the lateral extending portion 11c. The beam trap 15 absorbs a slight quantity of the laser light L that has transmitted through the dichroic mirror 14. Accordingly, the diffused reflection of the laser light L inside the housing 11 is suppressed.

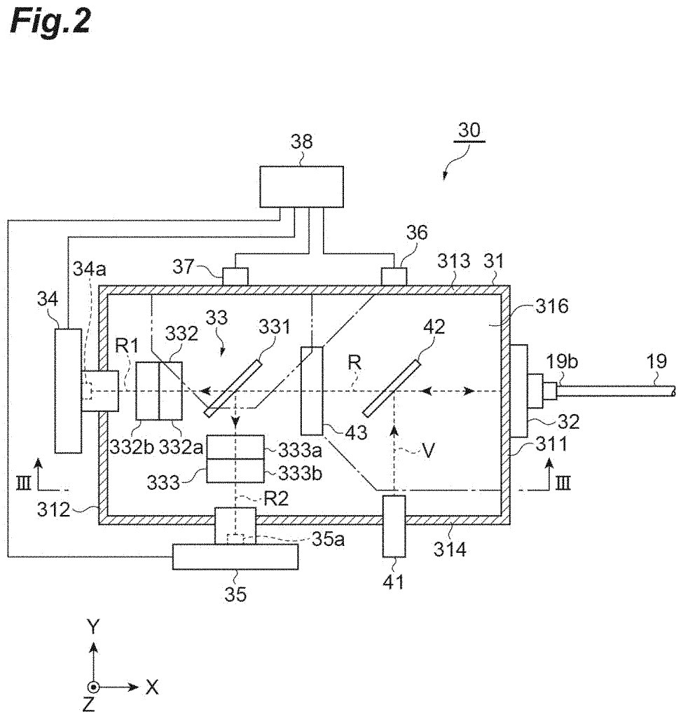

The second optical system 16 is disposed inside the upward extending portion 11d. The second optical system 16 condenses the thermal radiation light R that has entered from a dichroic mirror 14 side, on the light emission unit 17. As one example, the second optical system 16 is formed of two compound lenses. The compound lens disposed on the dichroic mirror 14 side is, for example, an achromatic collimator lens formed of two single lenses. The compound lens disposed on a light emission unit 17 side is, for example, an achromatic focus lens formed of three single lenses. In each of the compound lenses, chromatic aberration is corrected for light R1 of a first wavelength and light R2 of a second wavelength included in the thermal radiation light R (refer to FIG. 2).

The light emission unit 17 is attached to a tip portion of the upward extending portion 11d. One end portion 19a of an optical fiber 19 is connected to the light emission unit 17. The other end 19b of the optical fiber 19 is connected to the thermal radiation light detection device 30. The light emission unit 17 causes the thermal radiation light R condensed by the second optical system 16, to enter the optical fiber 19. The thermal radiation light R is guided to the thermal radiation light detection device 30 by the optical fiber 19. In the laser processing device 1, the laser processing head 10 and the optical fiber 19 function as a light guide unit that guides the thermal radiation light R emitted from the laser light irradiation region Sa, to the thermal radiation light detection device 30.

### [Configuration of Thermal Radiation Light Detection Device]

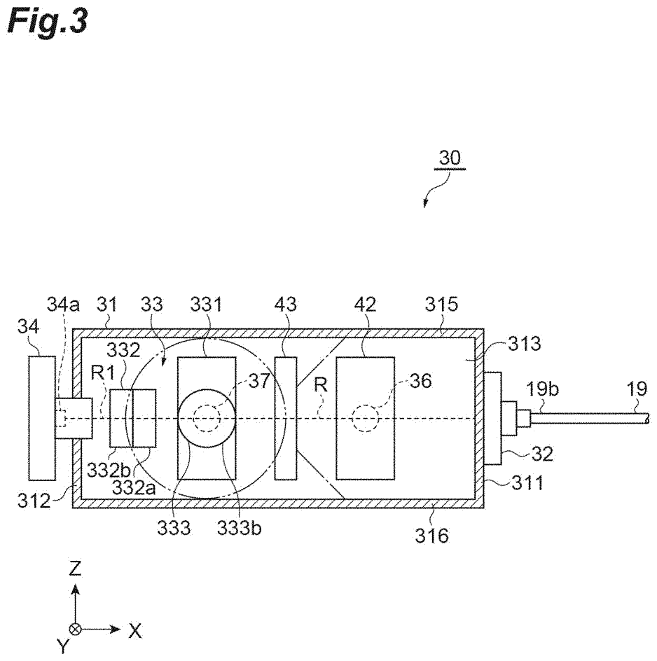

As shown in FIGS. 2 and 3, the thermal radiation light detection device 30 includes a housing 31, a light entrance unit 32, a light extraction unit 33, a first light detection unit 34, a second light detection unit 35, a first temperature detection unit 36, a second temperature detection unit 37, and a signal processing unit 38. Incidentally, in FIG. 3, the illustration of the signal processing unit 38 is omitted.

The housing 31 includes a plurality of wall portions 311, 312, 313, 314, 315 and 316. A pair of the wall portions 311 and 312 face each other in an X-axis direction. A pair of the wall portions 313 and 314 face each other in a Y-axis direction. A pair of the wall portions 315 and 316 face each other in a Z-axis direction. The wall portions 311, 312, 313, 314, 315 and 316 are flat wall portions that are partitioned off from each other by corners. However, as long as the wall portions 311, 312, 313, 314, 315 and 316 are wall portions that are partitioned off from each other by corners, the wall portions 311, 312, 313, 314, 315 and 316 are not limited to flat wall portions and may be curved wall portions. Incidentally, the corners that partition the wall portions 311, 312, 313, 314, 315 and 316 off from each other may be chamfered corners or non-chamfered corners.

The light entrance unit 32 is attached to the wall portion 311. The other end 19b of the optical fiber 19 is connected to the light entrance unit 32. The light entrance unit 32 causes the thermal radiation light R to enter the housing 31. The thermal radiation light R is light that is emitted from the laser light irradiation region Sa and is guided by the laser processing head 10 and the optical fiber 19 (refer to FIG. 1).

The light extraction unit 33 is disposed inside the housing 31. The light extraction unit 33 extracts the light R1 of the first wavelength and the light R2 of the second wavelength from the thermal radiation light R. The second wavelength is different from the first wavelength. In the present embodiment, the second wavelength is shorter than the first wavelength. As one example, the first wavelength is 2000 nm and the second wavelength is 1800 nm.

More specifically, the light extraction unit 33 is formed of a dichroic mirror 331, a first optical system 332, and a second optical system 333. The dichroic mirror 331 faces the light entrance unit 32 in the X-axis direction. The dichroic mirror 331 transmits light including the light R1 of the first wavelength of the thermal radiation light R that has entered from a light entrance unit 32 side, to a wall portion 312 side and reflects light including the light R2 of the second wavelength of the thermal radiation light R that has entered from the light entrance unit 32 side, to a wall portion 314 side.

The first optical system 332 is disposed between the dichroic mirror 331 and the wall portion 312. The first optical system 332 is formed of a first optical filter 332a and a first condenser lens 332b. The first optical filter 332a transmits the light R1 of the first wavelength of the light that has transmitted through the dichroic mirror 331, to a first condenser lens 332b side. The first condenser lens 332b condenses the light R1 of the first wavelength that has entered from a first optical filter 332a side, along the X-axis direction.

The second optical system 333 is disposed between the dichroic mirror 331 and the wall portion 314. The second optical system 333 is formed of a second optical filter 333a and a second condenser lens 333b. The second optical filter 333a transmits the light R2 of the second wavelength of the light reflected by the dichroic mirror 331, to a second condenser lens 333b side. The second condenser lens 333b condenses the light R2 of the second wavelength that has entered from a second optical filter 333a side, along the X-axis direction.

The first light detection unit 34 is attached to the wall portion 312. The first light detection unit 34 faces the first optical system 332 in the X-axis direction. The first light detection unit 34 includes a first light detection element 34a. The first light detection element 34a detects the light R1 of the first wavelength condensed by the first condenser lens 332b. The first light detection element 34a is, for example, a light-receiving element such as a photodiode disposed inside a CAN package.

The second light detection unit 35 is attached to the wall portion 314. The wall portion 312 to which the first light detection unit 34 is attached and the wall portion 314 to which the second light detection unit 35 is attached are different wall portions. The second light detection unit 35 faces the second optical system 333 in the Y-axis direction. The second light detection unit 35 includes a second light detection element 35a. The second light detection element 35a detects the light R2 of the second wavelength condensed by the second condenser lens 333b. The second light detection element 35a is, for example, a light-receiving element such as a photodiode disposed inside the CAN package.

The first temperature detection unit 36 is attached to the wall portion 313 different from the wall portion 312 to which the first light detection unit 34 is attached. The first temperature detection unit 36 is attached to the wall portion 313 intersecting the wall portion 312 to which the first light detection unit 34 is attached, and is located within a field of view (FOV) of the first condenser lens 332b on the wall portion 313. In FIGS. 2 and 3, the FOV of the first condenser lens 332b is shown by an alternate long and short dashed line. The first temperature detection unit 36 is, for example, a temperature detection element such as a thermistor having a small thermal time constant (for example, a thermal time constant of approximately 6 seconds). Incidentally, the FOV shown by the alternate long and short dashed line is not an FOV for the light R1 of the first wavelength, but an FOV for light of a wavelength that is thermal noise. The reason is that the first light detection unit 34 has sensitivity not only to the light R1 of the first wavelength but also to the light of the wavelength that is thermal noise and not only the light R1 of the first wavelength but also the light of the wavelength that is thermal noise enter the first light detection unit 34.

The second temperature detection unit 37 is attached to the wall portion 313 different from the wall portion 314 to which the second light detection unit 35 is attached. The wall portion 313 to which the first temperature detection unit 36 is attached and the wall portion 313 to which the second temperature detection unit 37 is attached are the same wall portion. The second temperature detection unit 37 is attached to the wall portion 313 facing the wall portion 314 to which the second light detection unit 35 is attached, and is located within an FOV of the second condenser lens 333b on the wall portion 313. In FIGS. 2 and 3, the FOV of the second condenser lens 333b is shown by an alternate long and two short dashed line. The second temperature detection unit 37 is, for example, a temperature detection element such as a thermistor having a small thermal time constant (for example, a thermal time constant of approximately 6 seconds). Incidentally, the FOV shown by the alternate long and two short dashed line is not an FOV for the light R2 of the second wavelength, but an FOV for light of a wavelength that is thermal noise. The reason is that the second light detection unit 35 has sensitivity not only to the light R2 of the second wavelength but also to the light of the wavelength that is thermal noise and not only the light R2 of the second wavelength but also the light of the wavelength that is thermal noise enter the second light detection unit 35.

The signal processing unit 38 obtains a temperature of a region (namely, the laser light irradiation region Sa) that has emitted the thermal radiation light R, based on a signal output from the first light detection unit 34 and a signal output from the second light detection unit 35. At this time, the signal processing unit 38 corrects the signal output from the first light detection unit 34, based on a signal output from the first temperature detection unit 36 and corrects the signal output from the second light detection unit 35, based on a signal output from the second temperature detection unit 37. The signal processing unit 38 is formed of, for example, a signal processing substrate into which a microprocessor is assembled, or a signal processing substrate into which a central processing unit is assembled.

As one example, when a light quantity of the light R1 of the first wavelength emitted from the workpiece S is Ms₁, a light quantity of light of the first wavelength emitted from the housing 31 and the like is I₁, and a light quantity of light of the first wavelength detected by the first light detection unit 34 is Mm₁, the following equation (1) is established. When the first wavelength is λ₁ and a temperature detected by the first temperature detection unit 36 is T₁, the following equation (2) is established (D₁, β₁, and C₁ are constants in the following equation (2)). The light quantity Ms₁ of the light R1 of the first wavelength emitted from the workpiece S is calculated from the following equations (1) and (2). Accordingly, the influence of the light quantity I₁ of the light of the first wavelength emitted from the housing 31 and the like can be excluded. The above processing corresponds to correction processing for correcting the signal output from the first light detection unit 34, based on the signal output from the first temperature detection unit 36.

Ms₁Mm₁−I₁ (1)

I₁=D₁+(β₁/λ₁⁵)·exp[−C₁/{λ₁(T₁+273.15)}] (2)

Similarly, when a light quantity of the light R2 of the second wavelength emitted from the workpiece S is Ms₂, a light quantity of light of the second wavelength emitted from the housing 31 and the like is I₂, and a light quantity of light of the first wavelength detected by the second light detection unit 35 is Mm₂, the following equation (3) is established. When the second wavelength is λ₂ and a temperature detected by the second temperature detection unit 37 is T₂, the following equation (4) is established (D₂, β₂, and C₂ are constants in the following equation (4)). The light quantity Ms₂ of the light R2 of the second wavelength emitted from the workpiece S is calculated from the following equations (3) and (4). Accordingly, the influence of the light quantity I₂ of the light of the second wavelength emitted from the housing 31 and the like can be excluded. The above processing corresponds to correction processing for correcting the signal output from the second light detection unit 35, based on the signal output from the second temperature detection unit 37.

Ms₂=Mm₂−I₂ (3)

I₂=D₂+(β₂/λ₂⁵)·exp[−C₂/{λ₂(T₂+23.15)}] (4)

The signal processing unit 38 obtains the temperature of the laser light irradiation region Sa from a ratio between the light quantity Ms₁ of the light R1 of the first wavelength emitted from the workpiece S and the light quantity Ms₂ of the light R2 of the second wavelength emitted from the workpiece S. This is the principle of a two-color radiation thermometer.

The thermal radiation light detection device 30 further includes a laser light source 41, a dichroic mirror 42, and an optical filter 43.

The laser light source 41 is attached to the wall portion 314. The laser light source 41 emits laser light V in a visible region into the housing 31 along the Y-axis direction.

The dichroic mirror 42 is disposed inside the housing 31 to face the light entrance unit 32 in the X-axis direction and to face the laser light source 41 in the Y-axis direction. The dichroic mirror 42 transmits the thermal radiation light R that has entered from the light entrance unit 32 side, to a dichroic mirror 331 side and reflects the laser light V that has entered from a laser light source 41 side, to the light entrance unit 32 side. The laser light V is guided by the optical fiber 19 and the laser processing head 10, and the workpiece S is irradiated with the laser light V. Since the laser light V is used as guide light, a position where the workpiece S is irradiated with the laser light L can be visually confirmed. In addition, since the laser light V is used as guide light, each configuration of the laser processing device 1 can be adjusted such that a processing position and a temperature measurement position on the workpiece S coincide with each other.

The optical filter 43 is disposed inside the housing 31 to be located between the dichroic mirror 42 and the dichroic mirror 331. The optical filter 43 transmits the thermal radiation light R that has entered from a dichroic mirror 42 side, to the dichroic mirror 331 side and removes scattered light and the like (scattered light and the like caused by the laser light L) that have entered from the dichroic mirror 42 side.

### [Actions and Effects]

In the thermal radiation light detection device 30, the light extraction unit 33 extracts the light R1 of the first wavelength and the light R2 of the second wavelength from the thermal radiation light R, the first light detection unit 34 detects the light R1 of the first wavelength, and the second light detection unit 35 detects the light R2 of the second wavelength. Accordingly, the temperature of the laser light irradiation region Sa can be obtained based on a signal output from the first light detection unit 34 and a signal output from the second light detection unit 35. Here, thermal radiation light emitted from the housing 31 enters each of the first light detection unit 34 and the second light detection unit 35, which is a concern. Particularly, thermal radiation light emitted from the wall portion 313 and the like different from the wall portion 312 to which the first light detection unit 34 is attached is likely to enter the first light detection unit 34. In addition, thermal radiation light emitted from the wall portion 313 and the like different from the wall portion 314 to which the second light detection unit 35 is attached is likely to enter the second light detection unit 35. Therefore, in the thermal radiation light detection device 30, the first temperature detection unit 36 is attached to the wall portion 313 different from the wall portion 312 to which the first light detection unit 34 is attached, and the second temperature detection unit 37 is attached to the wall portion 313 different from the wall portion 314 to which the second light detection unit 35 is attached. Accordingly, the signal output from the first light detection unit 34 can be corrected based on a signal output from the first temperature detection unit 36, and the signal output from the second light detection unit 35 can be corrected based on a signal output from the second temperature detection unit 37. As described above, the thermal radiation light detection device 30 and the laser processing device 1 enable highly accurate temperature measurement.

In addition, in order to correct the signal output from the first light detection unit 34 and the signal output from the second light detection unit 35, it is also conceivable that the thermal radiation light detection device 30 is provided with a mechanical mechanism such as a shutter. In that case, thermal radiation light emitted from the housing 31 and the like is detected by the first light detection unit 34 and the second light detection unit 35 in a state where the thermal radiation light R emitted from the workpiece S is prevented from entering the housing 31, and the signal output from the first light detection unit 34 and the signal output from the second light detection unit 35 are corrected by the signal. However, when the thermal radiation light detection device 30 is provided with the mechanical mechanism such as a shutter, a defect is likely to occur. On the other hand, in the thermal radiation light detection device 30 described above, since the mechanical mechanism such as a shutter is not required, a defect is unlikely to occur. Further, the thermal radiation light detection device 30 described above also enables high-speed repetitive measurements that cannot be followed by the mechanical mechanism such as a shutter.

In addition, in the thermal radiation light detection device 30, the first temperature detection unit 36 is located within the FOV of the first condenser lens 332b on the wall portion 313 to which the first temperature detection unit 36 is attached. Accordingly, the signal output from the first light detection unit 34 can be corrected with higher accuracy, based on the signal output from the first temperature detection unit 36. The reason is that thermal radiation light emitted from a portion of the wall portion 313 to which the first temperature detection unit 36 is attached is more likely to enter the first light detection unit 34, the portion being within the FOV of the first condenser lens 332b.

In addition, in the thermal radiation light detection device 30, the second temperature detection unit 37 is attached to the wall portion 313 facing the wall portion 314 to which the second light detection unit 35 is attached, and is located within the FOV of the second condenser lens 333b on the wall portion 313 to which the second temperature detection unit 37 is attached. Accordingly, the signal output from the second light detection unit 35 can be corrected with higher accuracy, based on the signal output from the second temperature detection unit 37. The reason is that thermal radiation light emitted from the wall portion 313 facing the wall portion 314 to which the second light detection unit 35 is attached is more likely to enter the second light detection unit 35. In addition, another reason is that thermal radiation light emitted from a portion of the wall portion 313 to which the second temperature detection unit 37 is attached is more likely to enter the second light detection unit 35, the portion being within the FOV of the second condenser lens 333b.

In addition, in the thermal radiation light detection device 30, the wall portion 312 to which the first light detection unit 34 is attached and the wall portion 314 to which the second light detection unit 35 is attached are different wall portions, and the wall portion 313 to which the first temperature detection unit 36 is attached and the wall portion 313 to which the second temperature detection unit 37 is attached are the same wall portion. Accordingly, the disposition of each configuration in the housing 31 can be simplified.

In addition, in the thermal radiation light detection device 30, the signal processing unit 38 obtains the temperature of the laser light irradiation region Sa based on the signal output from the first light detection unit 34 and the signal output from the second light detection unit 35. At this time, the signal processing unit 38 corrects the signal output from the first light detection unit 34, based on the signal output from the first temperature detection unit 36 and corrects the signal output from the second light detection unit 35, based on the signal output from the second temperature detection unit 37. Accordingly, the temperature of the laser light irradiation region Sa can be obtained with high accuracy.

### MODIFICATION EXAMPLES

In the embodiment, the light extraction unit 33 is formed of the dichroic mirror 331, the first optical system 332, and the second optical system 333, but the light extraction unit 33 may be formed of, for example, a half mirror, the first optical system 332, and the second optical system 333. The half mirror is a beam splitter that transmits some of the thermal radiation light R that has entered from the light entrance unit 32 side, to a first optical system 332 side and reflects the remainder of the thermal radiation light R to a second optical system 333 side. Namely, the light extraction unit 33 may be configured to extract the light R1 of the first wavelength and the light R2 of the second wavelength from the thermal radiation light R.

In addition, in the embodiment, the first condenser lens 332b that condenses the light R1 of the first wavelength on the first light detection element 34a is provided in the light extraction unit 33, but the first condenser lens that condenses the light R1 of the first wavelength on the first light detection element 34a may be provided in the first light detection unit 34, or the first condenser lenses may be provided in both the light extraction unit 33 and the first light detection unit 34.

In addition, in the embodiment, the second condenser lens 333b that condenses the light R2 of the second wavelength on the second light detection element 35a is provided in the light extraction unit 33, but the second condenser lens that condenses the light R2 of the second wavelength on the second light detection element 35a may be provided in the second light detection unit 35, or the second condenser lenses may be provided in both the light extraction unit 33 and the second light detection unit 35.

In addition, in the embodiment, the first temperature detection unit 36 is attached to the wall portion 312 intersecting the wall portion 313 to which the first light detection unit 34 is attached, but the first temperature detection unit 36 may be attached to any wall portion among the plurality of wall portions 311, 313, 314, 315, and 316 that is different from the wall portion 312 to which the first light detection unit 34 is attached. However, when the first temperature detection unit 36 is attached to the wall portion 311 facing the wall portion 312 to which the first light detection unit 34 is attached, a signal output from the first light detection unit 34 can be corrected with higher accuracy, based on a signal output from the first temperature detection unit 36. Further, when the first temperature detection unit 36 is located within the FOV of the first condenser lens (first condenser lens included in at least one of the light extraction unit 33 and the first light detection unit 34) on a wall portion to which the first temperature detection unit 36 is attached, the signal output from the first light detection unit 34 can be corrected with higher accuracy, based on the signal output from the first temperature detection unit 36.

In addition, in the embodiment, the second temperature detection unit 37 is attached to the wall portion 313 facing the wall portion 314 to which the second light detection unit 35 is attached, but the second temperature detection unit 37 may be attached to any wall portion among the plurality of wall portions 311, 312, 313, 315, and 316 that is different from the wall portion 314 to which the second light detection unit 35 is attached. However, when the second temperature detection unit 37 is attached to the wall portion 313 facing the wall portion 314 to which the second light detection unit 35 is attached, a signal output from the second light detection unit 35 can be corrected with higher accuracy, based on a signal output from the second temperature detection unit 37. Further, when the second temperature detection unit 37 is located within the FOV of the second condenser lens (second condenser lens included in at least one of the light extraction unit 33 and the second light detection unit 35) on a wall portion to which the second temperature detection unit 37 is attached, the signal output from the second light detection unit 35 can be corrected with higher accuracy, based on the signal output from the second temperature detection unit 37.

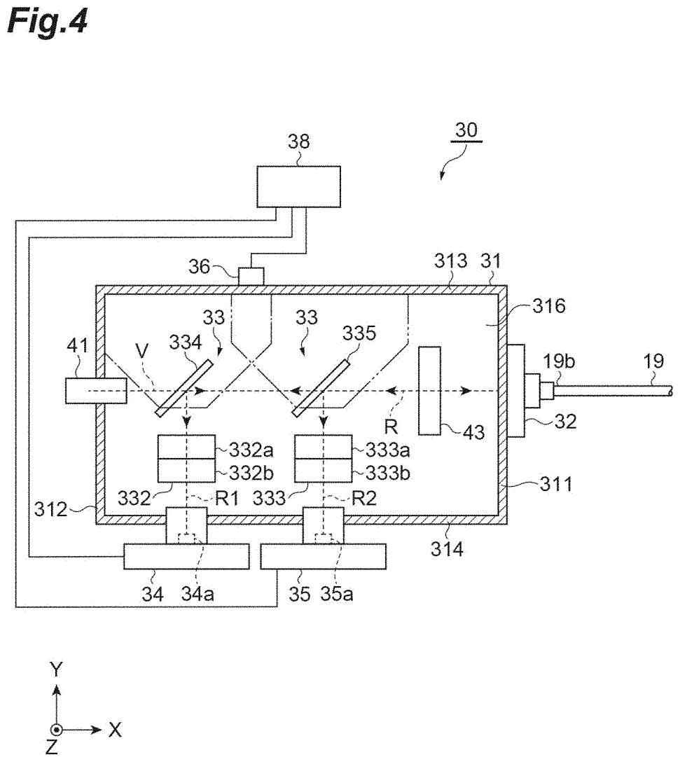

In addition, as shown in FIG. 4, a wall portion to which the first light detection unit 34 is attached and a wall portion to which the second light detection unit 35 is attached are the same wall portion. In that case, the first temperature detection unit 36 may be attached to a wall portion facing the wall portion to which the first light detection unit 34 and the second light detection unit 35 are attached. Accordingly, a signal output from the first light detection unit 34 and a signal output from the second light detection unit 35 can be corrected with higher accuracy, based on a signal output from the first temperature detection unit 36. Namely, it is not necessary to provide the second temperature detection unit 37 in the thermal radiation light detection device 30.

In addition, as shown in FIG. 4, the first temperature detection unit 36 may be located in a region where the FOV of the first condenser lens (first condenser lens included in at least one of the light extraction unit 33 and the first light detection unit 34) and the FOV of the second condenser lens (second condenser lens included in at least one of the light extraction unit 33 and the second light detection unit 35) overlap each other on the wall portion to which the first temperature detection unit 36 is attached. Accordingly, the signal output from the first light detection unit 34 and the signal output from the second light detection unit 35 can be corrected with higher accuracy, based on the signal output from the first temperature detection unit 36. Namely, it is not necessary to provide the second temperature detection unit 37 in the thermal radiation light detection device 30.

Hereinafter, a configuration of the thermal radiation light detection device 30 shown in FIG. 4 will be described. As shown in FIG. 4, the first light detection unit 34 and the second light detection unit 35 are attached to the wall portion 314. The second light detection unit 35 is located on a wall portion 311 side with respect to the first light detection unit 34. The light entrance unit 32 is attached to the wall portion 311. The laser light source 41 is attached to the wall portion 312. The laser light source 41 faces the light entrance unit 32 in the X-axis direction.

The light extraction unit 33 and the optical filter 43 are disposed inside the housing 31. The light extraction unit 33 is formed of a first dichroic mirror 334, a second dichroic mirror 335, the first optical system 332, and the second optical system 333. The first dichroic mirror 334 is disposed between the light entrance unit 32 and the laser light source 41 and faces the first light detection unit 34 in the Y-axis direction. The second dichroic mirror 335 is disposed between the light entrance unit 32 and the first dichroic mirror 334 and faces the second light detection unit 35 in the Y-axis direction. The first optical system 332 is disposed between the first dichroic mirror 334 and the first light detection unit 34. The second optical system 333 is disposed between the second dichroic mirror 335 and the second light detection unit 35. The optical filter 43 is disposed between the light entrance unit 32 and the second dichroic mirror 335.

The thermal radiation light R that has entered the housing 31 from the light entrance unit 32 transmits through the optical filter 43 and enters the light extraction unit 33. Scattered light and the like (scattered light and the like caused by the laser light L) that have entered the housing 31 from the light entrance unit 32 are removed by the optical filter 43. Light including the light R2 of the second wavelength of the thermal radiation light R that has entered the light extraction unit 33 is reflected to the second optical system 333 side by the second dichroic mirror 335. The light R2 of the second wavelength of the light reflected by the second dichroic mirror 335 transmits through the second optical filter 333a and is condensed by the second condenser lens 333b. The light R2 of the second wavelength condensed by the second condenser lens 333b is detected by the second light detection unit 35. Light including the light R1 of the first wavelength of the thermal radiation light R that has entered the light extraction unit 33 transmits through the second dichroic mirror 335 and is reflected to the first optical system 332 side by the first dichroic mirror 334. The light R1 of the first wavelength of the light reflected by the first dichroic mirror 334 transmits through the first optical filter 332a and is condensed by the first condenser lens 332b. The light R1 of the first wavelength condensed by the first condenser lens 332b is detected by the first light detection unit 34. The laser light V emitted from the laser light source 41 transmits through the first dichroic mirror 334, through the second dichroic mirror 335, and through the optical filter 43 and enters the light entrance unit 32.

The first temperature detection unit 36 is attached to the wall portion 313 facing the wall portion 314 to which the first light detection unit 34 and the second light detection unit 35 are attached. The first temperature detection unit 36 is located in the region where the FOV of the first condenser lens 332b (may be the first condenser lens included in at least one of the light extraction unit 33 and the first light detection unit 34) and the FOV of the second condenser lens 333b (may be the second condenser lens included in at least one of the light extraction unit 33 and the second light detection unit 35) overlap each other on the wall portion 313. In FIG. 4, the FOV of the first condenser lens 332b is shown by an alternate long and short dashed line, and the FOV of the second condenser lens 333b is shown by an alternate long and two short dashed line. The signal processing unit 38 obtains a temperature of a region (namely, the laser light irradiation region Sa) that has emitted the thermal radiation light R, based on a signal output from the first light detection unit 34 and a signal output from the second light detection unit 35. At this time, the signal processing unit 38 corrects the signal output from the first light detection unit 34 and the signal output from the second light detection unit 35, based on a signal output from the first temperature detection unit 36. Incidentally, when the first temperature detection unit 36 is located in a region where the FOV of the first condenser lens 332b (may be the first condenser lens included in at least one of the light extraction unit 33 and the first light detection unit 34) and the FOV of the second condenser lens 333b (may be the second condenser lens included in at least one of the light extraction unit 33 and the second light detection unit 35) overlap each other on a wall portion to which the first temperature detection unit 36 is attached, the wall portion to which the first temperature detection unit 36 is attached may be a wall portion facing a wall portion to which the first light detection unit 34 and the second light detection unit 35 are attached.

Various materials and shapes can be applied to each configuration in the above-described embodiment without being limited to the materials and shapes described above. In addition, each configuration in one embodiment or the modification examples described above can be arbitrarily applied to each configuration in another embodiment or modification example.

### REFERENCE SIGNS LIST

1: laser processing device, 10: laser processing head (light guide unit), 19: optical fiber (light guide unit), 20: laser light source, 30: thermal radiation light detection device, 31: housing, 32: light entrance unit, 33: light extraction unit, 34: first light detection unit, 34a: first light detection element, 35: second light detection unit, 35a: second light detection element, 36: first temperature detection unit, 37: second temperature detection unit, 38: signal processing unit, 311, 312, 313, 314: wall portion, 332b: first condenser lens, 333b: second condenser lens, L: laser light, R: thermal radiation light, R1: light of first wavelength, R2: light of second wavelength, S: workpiece, Sa: laser light irradiation region (region).

1. A thermal radiation light detection device comprising:
a housing including a plurality of wall portions;
a light entrance unit attached to a wall portion among the plurality of wall portions and configured to cause thermal radiation light to enter the housing;
a light extraction unit disposed inside housing and configured to extract light of a first wavelength and light of a second wavelength from the thermal radiation light, the second wavelength being different from the first wavelength;
a first light detection unit attached to a wall portion among the plurality of wall portions and configured to detect the light of the first wavelength;
a second light detection unit attached to a wall portion among the plurality of wall portions and configured to detect the light of the second wavelength; and
a first temperature detection unit attached to a wall portion among the plurality of wall portions, the wall portion to which the first temperature detection unit is attached being different from the wall portion to which the first light detection unit is attached.

2. The thermal radiation light detection device according to claim 1,
wherein the first temperature detection unit is attached to a wall portion among the plurality of wall portions, the wall portion to which the first temperature detection unit is attached facing the wall portion to which the first light detection unit is attached.

3. The thermal radiation light detection device according to claim 1,
wherein the first light detection unit includes a first light detection element configured to detect the light of the first wavelength,
at least one of the light extraction unit and the first light detection unit includes a first condenser lens configured to condense the light of the first wavelength on the first light detection element, and
the first temperature detection unit is located within an FOV of the first condenser lens on the wall portion to which the first temperature detection unit is attached.

4. The thermal radiation light detection device according to claim 1, further comprising:
a second temperature detection unit attached to a wall portion among the plurality of wall portions, the wall portion to which the second temperature detection unit is attached being different from the wall portion to which the second light detection unit is attached.

5. The thermal radiation light detection device according to claim 4,
wherein the second temperature detection unit is attached to a wall portion among the plurality of wall portions, the wall portion to which the second temperature detection unit is attached facing the wall portion to which the second light detection unit is attached.

6. The thermal radiation light detection device according to claim 4,
wherein the second light detection unit includes a second light detection element configured to detect the light of the second wavelength,
at least one of the light extraction unit and the second light detection unit includes a second condenser lens configured to condense the light of the second wavelength on the second light detection element, and
the second temperature detection unit is located within an FOV of the second condenser lens on the wall portion to which the second temperature detection unit is attached.

7. The thermal radiation light detection device according to claim 4,
wherein the wall portion to which the first light detection unit is attached and the wall portion to which the second light detection unit is attached are different wall portions, and
the wall portion to which the first temperature detection unit is attached and the wall portion to which the second temperature detection unit is attached are the same wall portion.

8. The thermal radiation light detection device according to claim 1,
wherein the wall portion to which the first light detection unit is attached and the wall portion to which the second light detection unit is attached are the same wall portion, and
the first temperature detection unit is attached to a wall portion among the plurality of wall portions, the wall portion to which the first temperature detection unit is attached facing the wall portion to which the first light detection unit and the second light detection unit are attached.

9. The thermal radiation light detection device according to claim 1,
wherein the first light detection unit includes a first light detection element configured to detect the light of the first wavelength,
the second light detection unit includes a second light detection element configured to detect the light of the second wavelength,
at least one of the light extraction unit and the first light detection unit includes a first condenser lens configured to condense the light of the first wavelength on the first light detection element,
at least one of the light extraction unit and the second light detection unit includes a second condenser lens configured to condense the light of the second wavelength on the second light detection element, and
the first temperature detection unit is located in a region where an FOV of the first condenser lens and an FOV of the second condenser lens overlap each other on the wall portion to which the first temperature detection unit is attached.

10. The thermal radiation light detection device according to claim 1, further comprising:
a signal processing unit configured to obtain a temperature of a region having emitted the thermal radiation light, based on a signal output from the first light detection unit and a signal output from the second light detection unit,
wherein the signal processing unit corrects at least the signal output from the first light detection unit, based on a signal output from the first temperature detection unit.

11. A laser processing device comprising:
the thermal radiation light detection device according to claim 1;
a laser light source configured to emit laser light; and
a light guide unit configured to guide thermal radiation light emitted from a region on a workpiece irradiated with the laser light, to the thermal radiation light detection device.
